(19) United States
(12) Patent Application Publication
(10) Pub. No.: US 2025/0205711 A1
(43) Pub. Date: Jun. 26, 2025

(54) COMBINED ROLLER SLEEVE, METHOD FOR PREPARING COMBINED ROLLER SLEEVE, AND PRESS ROLLER

(71) Applicant: CHINA ACADEMY OF MACHINERY ZHENGZHOU RESEARCH INSTITUTE OF MECHANICAL ENGINEERING CO., LTD., Zhengzhou (CN)

(72) Inventors: Zhiquan HUANG, Zhengzhou (CN); Junjie NI, Zhengzhou (CN); Haiyan ZHANG, Zhengzhou (CN); Wei YANG, Zhengzhou (CN); Yongsheng ZHANG, Zhengzhou (CN); Heng LI, Zhengzhou (CN); Jiaxu DUAN, Zhengzhou (CN)

(21) Appl. No.: 19/079,375

(22) Filed: Mar. 13, 2025

Related U.S. Application Data
(63) Continuation of application No. PCT/CN2024/075280, filed on Feb. 6, 2024.

(30) Foreign Application Priority Data
Feb. 20, 2023 (CN) 202310137943.8

(51) Int. Cl. B02C 4/30

(52) U.S. Cl. CPC B02C 4/305; B02C 2210/02

(57) ABSTRACT

Provided are a combined roller sleeve, a method for preparing the combined roller sleeve, and a press roller. The combined roller sleeve includes a first roller sleeve and a second roller sleeve that are separately formed and connected to each other. Connected end surfaces of the first roller sleeve and the second roller sleeve each have a notch in a circumferential direction. The notches are formed as a groove at a connection between the first roller sleeve and the second roller sleeve. First hard studs are embedded in the groove. Gaps between the first hard studs and between each of the first hard studs and a wall of the groove are filled with metallic surfacing layers.

### CROSS-REFERENCE TO RELATED APPLICATION

This application is a continuation of International Application No. PCT/CN2024/076280, filed on Feb. 6, 2024, which is based on and claims priority to Chinese Patent Application No. 202310137943.8 filed on Feb. 20, 2023, the entire contents of which are incorporated herein by reference.

### FIELD

The present disclosure relates to the field of crushing and grinding equipment technologies, and more particularly, to a combined roller sleeve for crushing and grinding, a preparation method therefor, and a press roller.

### BACKGROUND

In industries such as cement, mining, electric power, coal, and chemicals, the crushing and grinding of materials is often necessary. These operations typically use press rollers comprised of a roller sleeve and a roller shaft assembly. The roller sleeve is usually manufactured through casting. However, press rollers are becoming increasingly larger, leading to larger roller surface dimensions, such as ϕ1600×1400 mm, ϕ1700×1000 mm, ϕ1700×1400 mm, ϕ1800×1200 mm, and ϕ1800×1400 mm. Roller sleeves with a width exceeding 1000 mm are particularly susceptible to casting defects (the larger the size, the more frequent the defects) during the casting process. These defects include gas porosity, shrinkage, looseness, and cracks. These casting defects, when severe, can render the roller sleeve beyond repair, leading to direct scrapping. This results in material waste and increased production costs. The scrap rate is particularly high for roller sleeves with dimensions of ϕ1600×1400 mm and above.

To solve quality problems of large-sized roller sleeves in a casting process, recently, CN102274774A has proposed a combined roller sleeve. The combined shaft sleeve is composed of at least two combined sleeves arranged in an axial direction. In this way, a size of each combined roller sleeve can be significantly reduced, reducing a risk of quality defects in production and manufacturing of the large-sized roller sleeves. In this combined roller sleeve, it is troublesome for the roller sleeve to press a plurality of roller sleeves by retaining rings. Also, there is no metallurgical bonding between the roller sleeves, there is a predetermined gap between the roller sleeves, and connections between the roller sleeves are often subjected to impact and friction from materials during a production process. When a surface wear-resistant layer is worn off, the material enters between the roller sleeves through the gap, which is prone to cause wear on the roller sleeves.

In addition, problems such as stability of bonding between the roller sleeves and stress concentration at the connection may also easily affect wear resistance and stability of the roller sleeves, resulting in a short service life of the combined roller sleeve as a whole. Therefore, how to improve the wear resistance and stability of the combined roller sleeve is one of technical problems that need to be solved urgently.

Therefore, it is necessary to propose a combined roller sleeve in which the wear resistance and stability of the connection between the roller sleeves can be improved.

### SUMMARY

The present disclosure mainly solves a technical problem of providing a combined roller sleeve, a preparation method therefor, and a press roller, which can effectively improve wear resistance and stability of the combined roller sleeve.

To solve the above technical problems, embodiments of the present disclosure are to provide a combined roller sleeve including a first roller sleeve and a second roller sleeve that are separately formed and connected to each other. Connected end surfaces of the first roller sleeve and the second roller sleeve each have a notch in a circumferential direction. The notches are formed as a groove at a connection between the first roller sleeve and the second roller sleeve. First hard studs are embedded in the groove. Gaps between the first hard studs and between each of the first hard studs and a wall of the groove are filled with metallic surfacing layers.

Second hard studs are inlay-cast on the first roller sleeve and the second roller sleeve.

The first hard studs and the second hard studs protrude from a roller surface by the same height.

Wear-resistant alloy layers are formed on the first hard studs, the second hard studs, and roller surfaces between the first hard studs and the second hard studs through surfacing welding.

The first hard studs are made of hard alloy containing a carbide-based hard phase. The carbide-based hard phase includes one selected from the group consisting of titanium carbide, tungsten carbide, chromium carbide, vanadium carbide, niobium carbide, silicon carbide, and combinations thereof.

The metallic surfacing layers are formed through the surfacing welding by a welding wire having the same or similar material composition as the first roller sleeve and the second roller sleeve.

Each of the first roller sleeve and the second roller sleeve is made of high manganese steel. The metallic surfacing layers are formed through the surfacing welding by using a welding wire containing high manganese steel composition.

The second hard studs are made of the same material as the first hard studs.

The second hard studs are made of different material from the first hard studs. The first hard studs have greater hardness than the second hard studs.

Each of the first roller sleeve and the second roller sleeve has a cylindrical structure. The first roller sleeve and the second roller sleeve are sleeved over an outer wall of a roller shaft through interference fit in the same axial direction. The notches are formed along circumferences of the connected end surfaces of the first roller sleeve and the second roller sleeve.

The metallic surfacing layers include a first surfacing layer formed at a bottom of the groove and a second surfacing layer formed at an upper part of the groove. The first hard studs are welded on the first surfacing layer.

The first surfacing layer has a thickness ranging from 5 mm to 20 mm. The second surfacing layer has a thickness ranging from 20 mm to 40 mm.

Embodiments of the present disclosure are also to provide a method for preparing a combined roller sleeve. The method includes: preparing a first roller sleeve and a second roller sleeve, wherein an end of the first roller sleeve and an end of the second roller sleeve each have a notch in a circumferential direction; mounting the first roller sleeve and the second roller sleeve over a roller shaft, wherein the end of the first roller sleeve having the notch is connected to the end of the second roller sleeve having the notch, and wherein the notches are formed as a groove at a connection between the first roller sleeve and the second roller sleeve; forming a first surfacing layer by surfacing welding a wear-resistant alloy at a bottom of the groove in the circumferential direction; placing first hard studs in the groove and fixing the first hard studs on the first surfacing layer through spot welding; and filling the groove through the surfacing welding and forming a second surfacing layer between the first hard studs and between each of the first hard studs and a wall of the groove.

The first roller sleeve and the second roller sleeve are formed using a casting process.

The notches are formed during the casting forming of the first roller sleeve and the second roller sleeve.

The notches are formed on end surfaces of ends of the first roller sleeve and the second roller sleeve that are subjected to the casting forming.

In the casting forming of the first roller sleeve and the second roller sleeve, second hard studs are fixed in a sand-casting mold, and molten alloy steel is cast into the sand-casting mold and metallurgically bonded with the second hard studs to form the first roller sleeve and the second roller sleeve that are both inlay-cast with the second hard studs.

With the first roller sleeve and the second roller sleeve being mounted over the roller shaft, the first surfacing layer for connecting the first roller sleeve and the second roller sleeve is surfacing welded in the groove in the circumferential direction, and the first hard studs are fixed on the first surfacing layer in the groove through spot welding.

A welding wire for the surfacing welding during filling of the groove through the surfacing welding is formed through surfacing welding by using a welding wire containing the same or similar material composition as the first roller sleeve and the second roller sleeve.

The first roller sleeve and the second roller sleeve are each a high manganese steel casting. The welding wire for the surfacing welding during the filling of the groove through the surfacing welding is a welding wire containing high manganese steel composition.

The method further includes, subsequent to filling the groove by surfacing welding: forming wear-resistant alloy layers through the surfacing welding on the first hard studs, the second hard studs, and roller surfaces between the first hard studs and the second hard studs.

A welding wire for forming the wear-resistant alloy layers through the surfacing welding includes a manganese-nickel-chromium-based welding wire or a high-chromium cast iron welding wire.

The first surfacing layer has a thickness ranging from 5 mm to 20 mm. The second surfacing layer has a thickness ranging from 20 mm to 40 mm.

Embodiments of the present disclosure are also to provide a press roller. The press roller includes a roller shaft, and a combined roller sleeve including a first roller sleeve and a second roller sleeve that are separately formed. The first roller sleeve and the second roller sleeve are sleeved over the roller shaft and connected to each other. Connected end surfaces of the first roller sleeve and the second roller sleeve each have a notch in a circumferential direction. The notches are formed as a groove at a connection between the first roller sleeve and the second roller sleeve. First hard studs are embedded in the groove. Gaps between the first hard studs and between each of the first hard studs and a wall of the groove are filled with metallic surfacing layers.

Beneficial effects of the present disclosure will be provided below. Through a design of the combined roller sleeve, the roller sleeve of the large size can be designed as a combination of a plurality of roller sleeves of small size, which reduces a risk of quality defects occurring during casting forming of the roller sleeve. Meanwhile, a composite filling structure of the hard studs and the metallic surfacing layers is adopted at a connection of the combined roller sleeve, which can not only improve wear resistance and stability of the connection of the combined roller sleeve, but also improve stability of the connection of the combined roller sleeve.

### BRIEF DESCRIPTION OF THE DRAWINGS

FIG. 1 is a schematic cross-sectional view of a combined roller sleeve according to an embodiment of the present disclosure.

FIG. 2 is a schematic cross-sectional view of a combined roller sleeve according to another embodiment of the present disclosure.

FIG. 3 is a schematic view of a press roller according to an embodiment of the present disclosure.

### DETAILED DESCRIPTION OF THE EMBODIMENTS

Preferred embodiments of the present disclosure are described in detail below with reference to the accompanying drawings. Therefore, advantages and features of the present disclosure can be more easily understood by those skilled in the art, and the protection scope of the present disclosure can be more clearly defined.

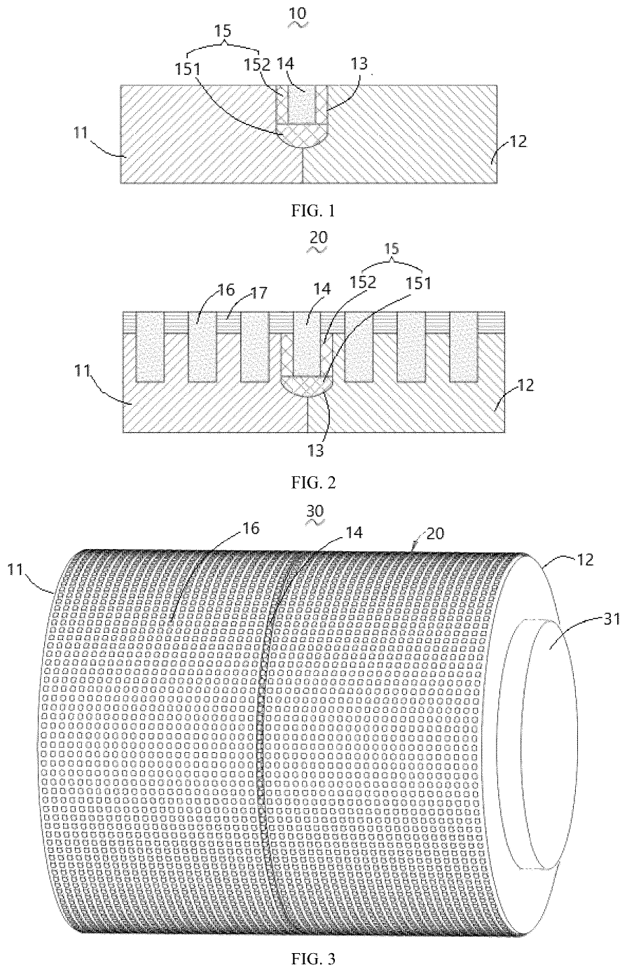

Referring to FIG. 1, a combined roller sleeve 10 according to a first embodiment of the present disclosure includes a first roller sleeve 11 and a second roller sleeve 12. The first roller sleeve 11 and the second roller sleeve 12 are separately formed through a casting process. The first roller sleeve 11 and the second roller sleeve 12 may each have a high manganese steel casting structure.

Each of the first roller sleeve 11 and the second roller sleeve 12 may have a cylindrical structure. The first roller sleeve 11 and the second roller sleeve 12 are sleeved over an outer wall of a roller shaft in one axial direction. An end of the first roller sleeve 11 is connected to an end of the second roller sleeve 12.

Connected end surfaces of the first roller sleeve 11 and the second roller sleeve 12 each have a notch in a circumferential direction. The notches are formed as a groove 13 at a connection between the first roller sleeve 11 and the second roller sleeve 12. First hard studs 14 are embedded in the groove 13. The first hard studs 14 may be evenly arranged at intervals along the circumferential direction. A top surface of each first hard stud 14 may be flush with a roller surface of each of the first roller sleeve 11 and the second roller sleeve 12, or may be higher than the roller surface of each of the first roller sleeve 11 and the second roller sleeve 12. A depth of each notch is set based on a length of the first hard stud 14, and typically ranges from 40 mm to 60 mm.

The first hard studs 14 are made of hard alloy. The hard alloy contains a carbide-based hard phase. The carbide-based hard phase includes one selected from the group consisting of titanium carbide, tungsten carbide, chromium carbide, vanadium carbide, niobium carbide, silicon carbide, and combinations thereof.

Gaps between the first hard studs 14 and between each of the first hard studs 14 and a wall of the groove 13 are filled with metallic surfacing layers 15 through surfacing welding. The metallic surfacing layers 15 may include a first surfacing layer 151 formed at a bottom of the groove 13 and a second surfacing layer 152 formed at an upper part of the groove 13. The first hard studs 14 are welded on the first surfacing layer 151. According to sizes of the first roller sleeve 11 and the second roller sleeve 12, the first surfacing layer 151 at the bottom of the groove 13 has a thickness ranging from 5 mm to 20 mm. The first surfacing layer 151 is used for connecting the two roller sleeves and protects the roller shaft from wear caused by materials entering the roller shaft along a gap between the two roller sleeves after the wear-resistant layer and the studs are worn and peeled off. In principle, the larger the sizes of the first roller sleeve 11 and the second roller sleeve 12 are, the thicker the first surfacing layer 151 is. The second surfacing layer 152 is filled between the first hard studs 14 and between each of the first hard studs 14 and the wall of the groove. The second surfacing layer 152 is configured to stably clamp the first hard studs 14, and is used for connecting the first hard studs 14, the first roller sleeve 11, and the second roller sleeve 12. The thickness of the first surfacing layer 151 and a thickness of the second surfacing layer 152 are selected based on both stability of welding of the first hard studs 14 in the groove 13 and bonding strength between the first hard studs 14 and the first roller sleeve 11 and between the first hard studs 14 and the second roller sleeve 12. According to repeated engineering experimental data, the first surfacing layer 151 may have a thickness ranging from 5 mm to 20 mm. The second surfacing layer may have a thickness ranging from 20 mm to 40 mm. The metallic surfacing layers 15 may be made of a welding wire having the same or similar material composition as the first roller sleeve 11 and the second roller sleeve 12. In this way, better metallurgical bonding between the metallic surfacing layer 15 and the first roller sleeve 11 and between the metallic surfacing layer 15 and the second roller sleeve 12 is realized. For example, a matrix material of each of the first roller sleeve 11 and the second roller sleeve 12 is high manganese steel. In this case, the metallic surfacing layer 15 may be made of a welding wire containing high manganese steel composition. The first surfacing layer 151 and the second surfacing layer 152 both belong to structural welds to ensure structural stability of the combined roller sleeve. The materials used may be the same or different.

A composite filling structure of the first hard studs 14 and the metallic surfacing layer 15 in the groove 13 may not only improve the wear resistance of a connection between the first roller sleeve 11 and the second roller sleeve 12, but also improve the stability of the connection of the first roller sleeve 11 and the second roller sleeve 12.

As illustrated in FIG. 2, second hard studs 17 are inlay-cast on the first roller sleeve 11 and the second roller sleeve 12 of a combined roller sleeve 20 according to another embodiment of the present disclosure. The first hard studs 14 and the second hard studs 17 protrude from a roller surface by the same height. When a connection area of the combined roller sleeve is located below a feed opening of a roller machine, the connection area of the combined roller sleeve is directly impacted by the materials. To prevent the connection area of the combined roller sleeve from being directly impacted by the materials, a size combination mode of the first roller sleeve and the second roller sleeve may be adjusted in such a manner that the feed opening is offset from the connection area of the combined roller sleeve. In this case, an impact of the materials on the connection area of the combined roller sleeve is not great, and the second hard studs 17 are made of the same material as the first hard studs 14. When the connection area fails to avoid the feed opening, the second hard stud 17 may be made of a different material from the first hard stud 14. Studs with better wear resistance may be selected for the first hard studs 14 in the connection area of the combined roller sleeve. In this case, the wear resistance of the first hard studs 14 is stronger than that of the second hard studs 17.

Further, wear-resistant alloy layers 16 may also be formed on the first hard studs 14, the second hard studs 17, and roller surfaces between the first hard studs 14 and the second hard studs 17 through the surfacing welding. The wear-resistant alloy layers 16 may be formed through the surfacing welding with a manganese-nickel-chromium-based stainless welding wire or a high-chromium cast iron welding wire. The wear-resistant alloy layers 16 may be flush with a top of each of the first hard studs 14 and the second hard studs 17, or may be higher than the top of each of the first hard studs 14 and the second hard studs 17 by 0 mm to 10 mm, or may be lower than the top of each of the first hard studs 14 and the second hard studs 17 by 0 mm to 2 mm. As illustrated in FIG. 3, the combined roller sleeve 20 may be adapted to a press roller 30 of the roller machine. The press roller 30 includes the roller shaft 31 and the combined roller sleeve 20 sleeved over the roller shaft 31 through interference fit.

It should be understood that, the combined roller sleeve may also be a combination of a plurality of roller sleeves. For example, a large-sized combined roller sleeve with a width of 1600 mm may be formed by combining two small-sized roller sleeves with a width of 800 mm, or may be formed by combining a roller sleeve with a width of 800 mm and two paired small-sized roller sleeves with a width of 400 mm. A method for preparing the combined roller sleeve according to the embodiment of the present disclosure includes: preparing a first roller sleeve and a second roller sleeve, in which an end of the first roller sleeve and an end of the second roller sleeve each have a notch; mounting the first roller sleeve and the second roller sleeve over a roller shaft, in which the end of the first roller sleeve having the notch is connected to the end of the second roller sleeve having the notch, and in which the notches are formed as a groove at a connection between the first roller sleeve and the second roller sleeve; forming a first surfacing layer configured to connect the first roller sleeve and the second roller sleeve in the groove in a circumferential direction; placing first hard studs in the groove and fixing the first hard studs; and filling the groove through the surfacing welding and forming a second surfacing layer between the first hard studs and between each of the first hard studs and a wall of the groove.

The first roller sleeve and the second roller sleeve are formed using a casting process. The notches may be formed in a casting forming process by design of molds, in such a manner that the notches are formed at a casting of the first roller sleeve and the second roller sleeve that have been cast. The notches may also be formed at end surfaces of an end of the first roller sleeve and an end of the second roller sleeve after casting forming through milling. The depth of the notch is set based on a length of each first hard stud, and typically ranges from 40 mm to 60 mm. The first surfacing layer 151 may have a thickness ranging from 5 mm to 20 mm. The second surfacing layer may have a thickness ranging from 20 mm to 40 mm.

Further, a plurality of second hard studs may also be inlay-cast on the first roller sleeve and the second roller sleeve. In the casting forming of the first roller sleeve and the second roller sleeve, the second hard studs are fixed in a sand-casting mold, and molten alloy steel is cast into the sand-casting mold and metallurgically bonded with the second hard studs to form the first roller sleeve and the second roller sleeve that are both inlay-cast with the second hard studs. The alloy steel may be a high manganese steel alloy.

With the first roller sleeve and the second roller sleeve being mounted over the roller shaft, the first hard studs may be fixed in the groove through spot welding. The first hard studs and the second hard studs at the first roller sleeve and the second roller sleeve protrude from a roller surface by the same height.

A welding wire for the surfacing welding during filling of the groove through the surfacing welding may be made of a welding wire containing the same or similar material composition as the first roller sleeve and the second roller sleeve. In this way, better metallurgical bonding between the metallic surfacing layer formed in the groove and the first roller sleeve and between the metallic surfacing layer formed in the groove and the second roller sleeve is realized. The first roller sleeve and the second roller sleeve are each a high manganese steel casting. Therefore, the welding wire is a welding wire containing high manganese steel composition.

Subsequent to filling the groove through the surfacing welding, wear-resistant alloy layers may also be formed through the surfacing welding on the first hard studs, the second hard studs, and roller surfaces between the first hard studs and the second hard studs. A welding wire for forming the wear-resistant alloy layers through the surfacing welding includes a manganese-nickel-chromium-based stainless welding wire or a high-chromium cast iron welding wire.

Although some embodiments of the present disclosure are described above, the scope of the present disclosure is not limited to the embodiments. Any equivalent structure or equivalent process transformation made using the contents of the specification and the accompanying drawings, or any direct or indirect application of the contents of the specification and the accompanying drawings in other related fields, shall equally fall within the scope of the present disclosure.

What is claimed is:

1. A combined roller sleeve, comprising a first roller sleeve and a second roller sleeve that are separately formed and connected to each other, wherein:
connected end surfaces of the first roller sleeve and the second roller sleeve each have a notch in a circumferential direction, the notches being formed as a groove at a connection between the first roller sleeve and the second roller sleeve;
first hard studs are embedded in the groove; and
gaps between the first hard studs and between each of the first hard studs and a wall of the groove are filled with metallic surfacing layers.

2. The combined roller sleeve according to claim 1, wherein second hard studs are inlay-cast on the first roller sleeve and the second roller sleeve.

3. The combined roller sleeve according to claim 2, wherein the first hard studs and the second hard studs protrude from a roller surface by the same height.

4. The combined roller sleeve according to claim 3, wherein wear-resistant alloy layers are formed on the first hard studs, the second hard studs, and roller surfaces between the first hard studs and the second hard studs through surfacing welding.

5. The combined roller sleeve according to claim 1, wherein the first hard studs are made of hard alloy containing a carbide-based hard phase, the carbide-based hard phase comprising one selected from the group consisting of titanium carbide, tungsten carbide, chromium carbide, vanadium carbide, niobium carbide, silicon carbide, and combinations thereof.

6. The combined roller sleeve according to claim 1, wherein the metallic surfacing layers are formed through surfacing welding by using a welding wire having the same or similar material composition as the first roller sleeve and the second roller sleeve.

7. The combined roller sleeve according to claim 6, wherein:
each of the first roller sleeve and the second roller sleeve is made of high manganese steel; and
the metallic surfacing layers are formed through the surfacing welding by using a welding wire containing high manganese steel composition.

8. The combined roller sleeve according to claim 2, wherein the second hard studs are made of the same material as the first hard studs.

9. The combined roller sleeve according to claim 2, wherein:
the second hard studs are made of different material from the first hard studs, the first hard studs having greater hardness than the second hard studs.

10. The combined roller sleeve according to claim 1, wherein:
each of the first roller sleeve and the second roller sleeve has a cylindrical structure;
the first roller sleeve and the second roller sleeve are sleeved over an outer wall of a roller shaft through interference fit in the same axial direction; and
the notches are formed along circumferences of the connected end surfaces of the first roller sleeve and the second roller sleeve, respectively.

11. The combined roller sleeve according to claim 1, wherein the metallic surfacing layers comprise a first surfacing layer formed at a bottom of the groove and a second surfacing layer formed at an upper part of the groove, the first hard studs being welded on the first surfacing layer.

12. The combined roller sleeve according to claim 11, wherein:
the first surfacing layer has a thickness ranging from 5 mm to 20 mm; and
the second surfacing layer has a thickness ranging from 20 mm to 40 mm.

13. A method for preparing a combined roller sleeve, the method comprising:
preparing a first roller sleeve and a second roller sleeve, wherein an end of the first roller sleeve and an end of the second roller sleeve each have a notch in a circumferential direction;
mounting the first roller sleeve and the second roller sleeve over a roller shaft, wherein the end of the first roller sleeve having the notch is connected to the end of the second roller sleeve having the notch, and wherein the notches are formed as a groove at a connection between the first roller sleeve and the second roller sleeve;
forming a first surfacing layer by surfacing welding a wear-resistant alloy at a bottom of the groove in the circumferential direction;
placing first hard studs in the groove and fixing the first hard studs on the first surfacing layer through spot welding; and
filling the groove through the surfacing welding and forming a second surfacing layer between the first hard studs and between each of the first hard studs and a wall of the groove.

14. The method according to claim 13, wherein the first roller sleeve and the second roller sleeve are prepared through casting forming.

15. The method according to claim 14, wherein the notches are formed during the casting forming of the first roller sleeve and the second roller sleeve.

16. The method according to claim 14, wherein the notches are formed on end surfaces of ends of the first roller sleeve and the second roller sleeve that are subjected to the casting forming.

17. The method according to claim 14, wherein in the casting forming of the first roller sleeve and the second roller sleeve, second hard studs are fixed in a sand-casting mold, and molten alloy steel is cast into the sand-casting mold and metallurgically bonded with the second hard studs to form the first roller sleeve and the second roller sleeve that are both inlay-cast with the second hard studs.

18. The method according to claim 13, wherein with the first roller sleeve and the second roller sleeve being mounted over the roller shaft, the first surfacing layer for connecting the first roller sleeve and the second roller sleeve is surfacing welded in the groove in the circumferential direction, and the first hard studs are fixed on the first surfacing layer in the groove through spot welding.

19. The method according to claim 13, wherein a welding wire for the surfacing welding during filling of the groove through the surfacing welding is formed by a welding wire containing the same or similar material composition as the first roller sleeve and the second roller sleeve through the surfacing welding.

20. The method according to claim 19, wherein:
the first roller sleeve and the second roller sleeve are each a high manganese steel casting, and
the welding wire for the surfacing welding during the filling of the groove through the surfacing welding is a welding wire containing high manganese steel composition.

21. The method according to claim 17, further comprising, subsequent to filling the groove through the surfacing welding:
forming wear-resistant alloy layers through the surfacing welding on the first hard studs, the second hard studs, and roller surfaces between the first hard studs and the second hard studs.

22. The method according to claim 21, wherein a welding wire for forming the wear-resistant alloy layers through the surfacing welding comprises a manganese-nickel-chromium-based welding wire or a high-chromium cast iron welding wire.

23. The method according to claim 13, wherein:
the first surfacing layer has a thickness ranging from 5 mm to 20 mm; and
the second surfacing layer has a thickness ranging from 20 mm to 40 mm.

24. A press roller, comprising:
a roller shaft; and
a combined roller sleeve comprising a first roller sleeve and a second roller sleeve that are separately formed, the first roller sleeve and the second roller sleeve being sleeved over the roller shaft and connected to each other, wherein:
connected end surfaces of the first roller sleeve and the second roller sleeve each have a notch in a circumferential direction, the notches being formed as a groove at a connection between the first roller sleeve and the second roller sleeve;
first hard studs are embedded in the groove; and
gaps between the first hard studs and between each of the first hard studs and a wall of the groove are filled with metallic surfacing layers.
